(19) United States
(12) Patent Application Publication
(10) Pub. No.: US 2026/0116203 A1
(43) Pub. Date: Apr. 30, 2026

(54) SYSTEM FOR PERFORMING BLOCKCHAIN PROCESSING WITHIN A VEHICLE

(71) Applicant: FCA US LLC, Auburn Hills, MI (US)

(72) Inventor: Andrew D Johnson, Auburn Hills, MI (US)

(21) Appl. No.: 18/926,433

(22) Filed: Oct. 25, 2024

(51) Int. Cl. B60L 7/18; H04L 9/00

(52) U.S. Cl. CPC B60L 7/18; H04L 9/50; B60L 2240/54

(57) ABSTRACT

A system to use vehicle regenerative braking to power blockchain processing may include a controller that includes one or more processors, memory and instructions or programs stored in the memory or otherwise accessible by the processors that is capable of communicating with a network configured to transmit and receive blockchain data. A blockchain processor may be either integrated with the controller or separate from the controller and is capable of communicating with the controller. The system determines a vehicle energy condition, determines whether the vehicle energy condition is above a predetermined threshold and powers one or more blockchain processors to perform blockchain processing when the vehicle energy condition meets or exceeds the predetermined threshold.

### FIELD

The present disclosure relates to performing blockchain processing within a vehicle.

### BACKGROUND

Regenerative braking systems may be engaged to slow the vehicle and/or to charge a vehicle battery. However, if the battery is fully charged or above a predetermined level of charge, use of the regenerative braking system may subject the battery to overcharging. Vehicles may adjust the magnitude of regenerative braking based on the battery's current charge status to avoid overcharging the battery. In areas with sustained declines where regenerative braking may be particularly useful to control vehicle speed and generate energy, having a charged battery may result in reduced braking performance due to increased reliance and stress on the friction brakes. Additionally, to prevent overcharging the battery when using regenerative braking, some vehicles may consume energy from the battery to power unneeded vehicle accessories or can use energy from the battery in the form of heat dissipation using one or more resistors. However, this energy is wasted because but for preventing overcharging, the energy used would be stored in the battery.

### SUMMARY

In at least some implementations, a method for using regenerative braking of a vehicle to power blockchain processing, includes determining a vehicle energy condition, determining whether the vehicle energy condition is greater than a predetermined threshold, and powering one or more blockchain processors to perform blockchain processing when the vehicle energy condition satisfies the predetermined threshold.

In at least some implementations, the method also includes determining that additional regenerative braking is presently occurring or is going to occur based on a projected route of the vehicle, and wherein the step of powering one or more processors occurs when both a vehicle battery is charged above a predetermined level and when additional regenerative braking is presently occurring or is going to occur based on a path of travel of the vehicle.

In at least some implementations, the step of powering one or more block chain processors to perform blockchain processing is accomplished by providing power from a vehicle battery to the one or more processors.

In at least some implementations, the step of powering one or more processors to perform blockchain processing starts after a vehicle battery has reached a predetermined level of charge or stops when the vehicle battery has fallen to a predetermined level of charge

In at least some implementations, the step of powering one or more processors to perform blockchain processing may be selectively started or stopped based on a location of the vehicle.

In at least some implementations, the step of powering one or more processors to perform blockchain processing may be selectively started when the vehicle is on a road or is projected to be on a road having elevation decline greater than a predetermined amount.

In at least some implementations, performing blockchain processing may be selectively stopped when one or more vehicle accessories require more than a predetermined amount of power from the vehicle battery.

In at least some implementations, performing blockchain processing includes performing blockchain calculations as part of a processing pool.

In at least some implementations, performing blockchain processing includes blockchain-based vehicle data tracking.

In at least some implementations, performing blockchain processing includes collecting unconfirmed transactions from a network, organizing transactions into a new block, referring to previous block creating chain of blocks, and producing a hash that meets specific criteria of a blockchain.

In at least some implementations, a system for using regenerative braking of a vehicle to power blockchain processing includes a controller that includes one or more processors, memory and instructions or programs stored in the memory or otherwise accessible by the processors that is capable of communicating with a network configured to transmit and receive blockchain data, and a blockchain processor. The blockchain processor is either integrated with the controller or separate from the controller and is capable of communicating with the controller to: determine a vehicle energy condition, determine whether the vehicle energy condition is greater than a predetermined threshold, and power one or more blockchain processors to perform blockchain processing when the vehicle energy condition meets or exceeds the predetermined threshold.

In at least some implementations, the system also includes determining that additional regenerative braking is presently occurring or is going to occur based on a projected route of the vehicle, and wherein the step of powering one or more processors occurs when both a vehicle battery is charged above a predetermined level and when additional regenerative braking is presently occurring or is going to occur based on a path of travel of the vehicle.

In at least some implementations, powering one or more block chain processors to perform blockchain processing is accomplished by providing power from a vehicle battery to the one or more processors.

In at least some implementations, powering one or more processors to perform blockchain processing starts after a vehicle battery has reached a predetermined level of charge or stops when the vehicle battery has fallen to a predetermined level of charge.

In at least some implementations, powering one or more processors to perform blockchain processing may be selectively started or stopped based on a location of the vehicle.

In at least some implementations, powering one or more processors to perform blockchain processing may be selectively started when the vehicle is on a road or is projected to be on a road having elevation decline greater than a predetermined amount.

In at least some implementations, performing blockchain processing may be selectively stopped when one or more vehicle accessories require more than a predetermined amount of power from the vehicle battery.

In at least some implementations, performing blockchain processing includes performing blockchain calculations as part of a processing pool.

In at least some implementations, performing blockchain processing includes blockchain-based vehicle data tracking.

In at least some implementations, performing blockchain processing includes collecting unconfirmed transactions from a network, organizing transactions into a new block, referring to previous block creating chain of blocks, and producing a hash that meets specific criteria of a blockchain.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic of a system for performing blockchain processing within a vehicle; and

FIG. 2 shows a flow chart for a method for performing blockchain processing within a vehicle.

### DETAILED DESCRIPTION

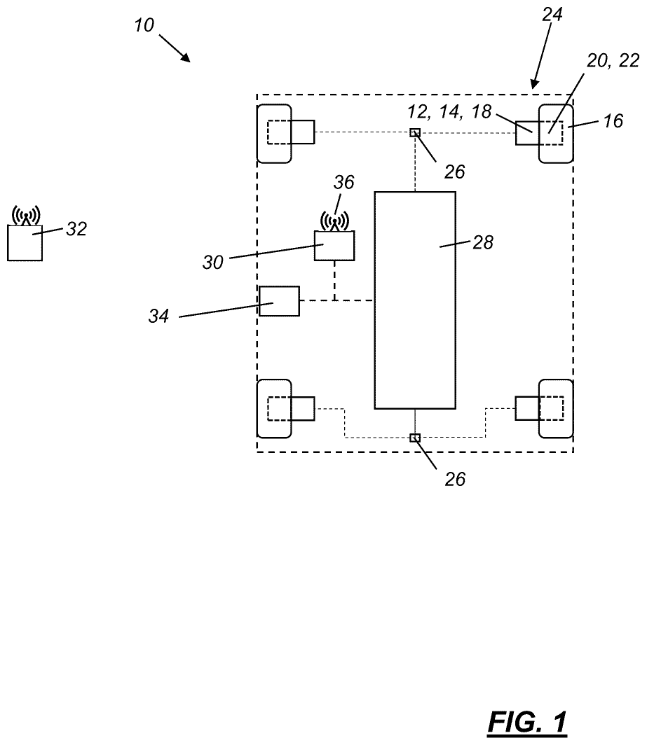

Referring in more detail to the drawings, FIG. 1 illustrates a vehicle 10 having a propulsion system 12 including a prime mover 14 coupled to multiple wheels 16 to propel the vehicle 10. The prime mover 14 could be an electric motor 18, a combustion engine, or both, as desired. Further, with electric motors 18, one or more motors 18 may be used to power individual axles/shafts or wheels 16, as desired. To slow and stop the vehicle 10, the vehicle 10 includes a primary braking system 20. The primary braking system 20 includes multiple brake assemblies 22, each associated with a different one and up to each wheel 16 of the vehicle 10. The brake assemblies 22 may be friction brakes of known types. Further, the vehicle may include a regenerative braking system 24.

The regenerative braking system 24 may include one or more electric motors 18, an inverter 26, and a battery 28. There may be one or multiple batteries 28 in a vehicle 10, as desired, and for ease of description, this document will refer to the battery 28 as a singular component, without any intention to limit the disclosure to a single battery. The battery 28 may be mounted to or within the vehicle 10 and may be one or more interconnected cells arranged in series and/or parallel to achieve a desired voltage and capacity for energy storage. Any suitable battery composition may be used, including but not limited to lithium-ion, nickel-metal hydride, lead-acid types.

The one or more electric motors 18 may serve dual purposes of converting electrical energy to mechanical, kinetic energy to propel the vehicle 10 and to act as a generator to convert kinetic energy to electrical energy that can be stored in a suitable charge storage device such as capacitors or the vehicle battery 28 or batteries. Thus, when the vehicle 10 is in motion and no electricity is being supplied to the one or more electric motors 18, the kinetic energy of the vehicle 10 may be used to spin the one or more electric motors 18 to generate electricity that may be used to power electrical components and/or to charge the battery 28. One or more inverters 26 may be used to convert direct current from the battery 28 to alternating current to power the one or more electric motors 18, and to convert alternating current generated by the one or more electric motors 18 during regenerative braking to direct current to charge the battery 28 or for other use.

A control system 30 may be in communication with the prime mover 14, the battery 28, and the regenerative braking system 24 to manage the power expended by the battery 28 to power the one or more electric motors 18 and the power used to charge the battery 28 from the regenerative braking system 24. Further, at least when the primary braking system 20 is a so-called brake-by-wire system, where a braking input is communicated with an electric brake actuator, the control system 30 may communicate with and control the electric brake actuator to manage the braking power provided by the primary braking system 20, in at least some implementations. The control system 30 has one or more controllers or processors, memory, and instructions or programs stored in the memory or otherwise accessible by the processor(s). In some implementations, the control system 30 may have or be defined by a plurality of vehicle controllers independent from each other or networked together. Each of the controllers may communicate with one or more vehicle components, system components, or a network 32.

The vehicle 10 may also include a blockchain processor 34 that may be the same component as the one or more controllers or processors of the control system 30, may be integrated with the control system 30, or may be a separate component from the control system 30. The blockchain processor 34 may be configured to perform blockchain processing, such as mining or other blockchain operations, and may have high clock speeds and multiple cores to effectively handle blockchain processing. In at least some implementations, parallel processing may be implemented by the blockchain processor 34 to divide cryptographic calculations between multiple cores of the blockchain processor 34 to perform blockchain processing.

Blockchain processing may include a decentralized digital ledger spread amongst a network of computers and processors configured to prevent registered transactions from being retroactively altered without the alteration of all subsequent blocks of the blockchain. For example, each block may contain a list of transactions, a timestamp, and a cryptographic hash of the previous block. The blocks are linked in chronological order, forming a blockchain. A blockchain may be distributed across a network of nodes where each node maintains a copy of the entire blockchain to ensure each block's accuracy.

To perform blockchain processing, a computer or processor performs work, often in the form of solving cryptographic puzzles or calculations to validate transactions, to obtain an award of digital currency. First the processor or computer collects data from an unconfirmed transaction from the network 32. The processor organizes transactions into a new block, competing with, or in some cases such as pool mining, assisting other processing devices to find a nonce (a random number), that when hashed with the block's data using a cryptographic function, such as SHA-256, produces a hash that meets specific criteria. Once a valid nonce is hashed, the new block is broadcast to the network 32 for verification by other processing devices. After verification, the miner or user of the processor or computer receives a reward, usually a portion of the transaction fees associated with the transaction to be verified, or a predetermined amount of cryptocurrency in some embodiments of blockchain processing. In some networks 32, miners earn both the block reward (newly minted cryptocurrency) and transaction fees from the transactions verified in the block.

In at least some embodiments, blockchain processing includes pool processing or mining, where resources are combined from multiple miners in a network 32 to complete a block. Pool mining increases the likelihood of solving the cryptographic calculations required to add new blocks to the blockchain by increasing the computing power available and decreasing the time to find a valid nonce, resulting in more frequent rewards that may be divided between the members of the pool based on resources used by each member.

In some embodiments, blockchain processing may include vehicle data to assist in securely storing and tracking vehicle data. Vehicle data tracking on blockchain may involve, by way of non-limiting examples, using blockchain technology to securely record, store, and share data related to vehicles and their usage. For example, a token may be implemented in the network 32 or in the vehicle's systems to track maintenance, service records, vehicle mileage, vehicle driving conditions, or driving history. This vehicle data may be validated by other computers or processors in blocks to form a blockchain which makes it very unlikely that the information can later be falsified.

In order to perform the functions and desired processing set forth herein, as well as the computations therefore, the control system 30 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing. For example, the control system 30 may include input signal processing and filtering to enable accurate sampling and conversion or acquisitions of such signals from communications interfaces and sensors. As used herein the terms control system may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 30 may be distributed among different vehicle modules, such as an infotainment system control module, engine control module or unit, powertrain control module, transmission control module, and the like, if desired, and the memory and one or more processors may be one or both integrated into the vehicle 10 or remotely located and wirelessly communicated to the vehicle 10, as desired.

The blockchain processor 34 may be a similar controller or controllers or one or more processors as set forth for the control system 30. The blockchain processor 34 may perform central processing unit (CPU), graphic processing unit (GPU) or ASIC type processing, or combinations thereof, by way of non-limiting examples.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

The vehicle 10 also has a communication device 36, such as a telematics unit, having a receiver that is capable of receiving information sent wirelessly to the vehicle and a transmitter capable of transmitting information wirelessly from the vehicle 10. The communication device 36 is communicated with the control system 30, and with the blockchain processor 34 to permit communication of the blockchain processor 34 with the blockchain and/or networked miners and the like, to enable the blockchain processor 34 to actively participate in the processing. The communication device 36 may use a cellular-based network, a satellite-based network, a city-wide WiFi-based network, or other local or wide area communication network and/or a combination thereof.

The regenerative braking systems 24 may be engaged to slow the vehicle 10 and to charge the battery 28. In some instances, such as steep or longer distance declines in hilly areas, regenerative braking systems 24 may be used to supplement the friction brakes 20, possibly to prevent overheating of the brake assemblies 22 due to continuous use. However, if the battery 28 is fully charged or above a predetermined level of charge, use of the regenerative braking system 24 may subject the battery 28 to overcharging. Many modern vehicles provide feedback to the driver about the state of charge and may adjust the regenerative braking strength based on the battery's 28 current charge status. Therefore, drivers might notice less or no regenerative braking effect when the battery 28 is fully charged or above a predetermined level of charge. Additionally, to prevent overcharging of the battery 28 and still permit some regenerative braking, some vehicles may use energy from the battery 28 to power vehicle accessories or can use energy from the battery 28 in the form of heat dissipation using one or more resistors. A drawback to this way of preventing overcharging is that but for preventing overcharging the energy used would be stored in the battery 28. Thus, energy consumed to prevent overcharging of the battery 28 is wasted.

In at least some implementations, the regenerative braking system 24 is used to provide energy to power the blockchain processor 34 and related components (e.g. the communications device) needed to perform blockchain processing. To avoid unduly reducing the energy available to propel the vehicle 10 (e.g. electricity available to the motors 18), the system may be controlled to permit blockchain processing by the blockchain processor 34 only when the charge level of the vehicle battery 28 is above a threshold, and/or only under certain energy conditions, such as when significant regenerative braking is occurring or likely to occur, and/or vehicle motive energy use is low. Parameters to control the use of energy for blockchain processing by the vehicle blockchain processor 34 are disclosed herein.

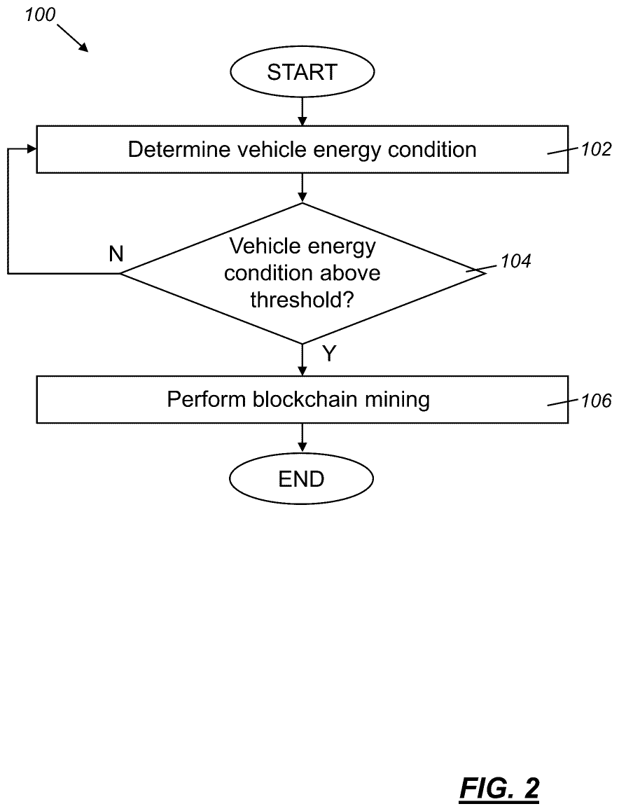

FIG. 2 depicts a method 100 for performing blockchain processing/calculations in the vehicle 10. In step 102, a vehicle energy condition is determined. The vehicle energy condition may include factors such as the battery charge level, the current range of the vehicle 10 (e.g. distance that can be driven based on the energy available), the current range of the vehicle 10 compared to a distance to a known destination of the vehicle 10, and the projected energy generation by the regenerative braking system 24 based on location of the vehicle 10 or the vehicle's projected route. A further factor that may be considered is the energy consumption assumed for a given blockchain processing duration or process. Some blockchain activities consume more energy than others, and so based on the type or amount or duration or other factor related to the blockchain processing to be performed, is a factor as to whether to allow the blockchain processing to occur at a given time or not.

The battery charge level in combination with one or more sensors to detect the speed of the vehicle 10, and/or an assumed average energy use of the vehicle 10 in different driving conditions (e.g. city or highway driving) may be used to estimate the travel range of the vehicle 10. If the vehicle 10 is determined to have above a predetermined travel range, the vehicle energy condition may be favorable in this regard which makes a decision to allow blockchain processing more likely.

Next, to determine the projected energy generation by the regenerative braking system 24 in use of the vehicle, the control system 30 may use a global positioning system (GPS) to determine the location of the vehicle 10, and map data that includes information about roads on which the vehicle 10 is traveling. If the vehicle 10 is traveling on a road known to have steep and/or sustained declines, or if the vehicle 10 is in an area having traffic or intersections or more frequent stop and go type driving where regenerative braking can be used often to slow the vehicle speed, the vehicle energy condition may be favorable to permit blockchain processing as more energy may be determined to be available via the regenerative braking system 24. The area in which the vehicle 10 is located may also include inclines and higher speed limit roads where greater vehicle energy use may be needed to propel the vehicle 10. This information tends to suggest that blockchain processing should not be permitted.

Beyond the area in which the vehicle 10 is currently located, the projected route or destination of the vehicle 10 may be known if a destination is entered into a vehicle navigation system (or a navigation system of a device coupled to the vehicle 10, such as a smart phone, tablet or computer). The vehicle energy condition can be evaluated in view of the projected route of the vehicle 10 as a function of: a) the distance to the destination and the vehicle range; and b) the level of regenerative braking likely to occur along the projected route. The vehicle range may be determined as a function of energy use needed to propel the vehicle 10 to the destination and may take into account regenerative braking opportunities that can increase vehicle range as well as inclines and other driving conditions that decrease vehicle range.

In step 104, it is determined whether the vehicle energy condition is above a predetermined threshold, in which case the method proceeds to step 106 and blockchain processing is performed by providing power to the blockchain processor 34. If the threshold is not met by the energy condition(s) of the vehicle 10, then the method returns to step 102 without powering the blockchain processor 34 and without performing blockchain processing.

The predetermined threshold may be any of the factors considered in the vehicle energy condition as mentioned herein, or a combination of more than one and up to all factors. For example, the predetermined threshold may be a battery charge level, a vehicle range, a location of the vehicle 10, or a current or projected distance and terrain over which the vehicle 10 will travel. Depending on the embodiment one or more factors may be required to obtain a vehicle energy condition that satisfies the predetermined threshold.

Further, the factors may be weighted differently, and not all factors need be considered for each determination, or considered in the same way. For example, in some implementations, a lower battery charge level and/or lower vehicle range may be present but the threshold still met if the projected route indicates greater regenerative braking energy generation, while the opposite may also be true (e.g. a higher battery charge level or higher vehicle range may be needed if the vehicle location or route indicate low energy generation will occur by regenerative braking). Here, the control system 30 includes instructions or programming by which a decision is made whether to allow blockchain processing by the blockchain processor and related components. Under some energy conditions blockchain processing is not permitted and, under other energy conditions, blockchain processing is permitted.

In step 106, blockchain processing may be performed by the blockchain processor 34. In at least some implementations, because blockchain processing can be energy intensive, it may be advantageous to start or stop blockchain processing based at least partially on the vehicle energy condition. This may allow the user to reach their intended destination without any concerns of running out of motive power. Furthermore, blockchain processing may be used to prevent battery overcharging. When the battery 28 is above a predetermined level, blockchain processing may be started as an alternative to wasting energy by powering unneeded vehicle accessories or using resistors to consume excess electrical energy. Blockchain processing may be used to productively consume energy from the battery 28, permitting the use of regenerative braking even when the battery 28 is fully charged or is charged above a predetermined level. This may alleviate or reduce stress on the friction brake system 20 by supplementing stopping power with the regenerative braking system 24 without overcharging the battery 28.

In other embodiments, blockchain processing may be initiated by a user of the vehicle 10, or terminated or prevented from starting, by a user. The vehicle 10 may provide a display of one or more aspects of the vehicle energy condition to the user, allowing the user to make an educated decision on when blockchain processing should be started. For example, the projected energy generation based on the speed, location, or projected route of the vehicle 10 may be communicated to the user through known display or communication means within a vehicle 10. A projected range based on, for example, the battery charge level, the location of the vehicle 10, or the projected route of the vehicle 10, among others, may be communicated to the user.

Blockchain processing, once started, may be stopped at any time by a user, or by the control system 30, if the vehicle energy condition changes. For example, the battery 28 may fall to a predetermined level of charge, the range may fall to a predetermined level of range, other vehicle accessories may require above a predetermined amount of energy, or the projected vehicle route may change requiring more energy or providing less power generation by regenerative braking. Some blockchain processing enables rewards to be attained by the blockchain processor 34 even in short durations of blockchain processing utilizing blockchain processing pools, or otherwise. For example, with processing pools, the work is divided and the reward is granted between multiple mining processors of multiple vehicles or machines. Thus, even if the blockchain processor of the vehicle 10 cannot complete a transaction or task, such as finding the correct nonce, before blockchain processing is stopped, if another member of the processing pool completes the cryptographic operation, the vehicle's blockchain processor 34 may still be awarded based on the portion of work performed related to the other members of the pool. This allows the user of the vehicle to attain at least a portion of the rewards, so that the energy consumed by the blockchain processor 34 is not wasted (beyond the benefit of protecting the battery 28 from overcharging, if applicable in a given situation).

The systems and methods 100 consider the vehicle energy before permitting use of a blockchain processor 34, or use of a processor of the vehicle 10 for blockchain computations or processing. The energy conditions considered may include both expected or actual energy use to propel the vehicle 10 and power vehicle systems, as well as energy generation opportunities from the regenerative braking system 24. Further, the blockchain processor 34 can advantageously be operated to consume energy and prevent a battery overcharge condition, while potentially earning money for the vehicle owner via the blockchain processing. While some specific examples of blockchain transactions were noted (e.g. nonce determination), this disclosure is not limited to any particular blockchain processing, or to computer processing that results in mining or monetary reward. The blockchain processor 34 may perform calculations and functions other than blockchain processing unrelated to operation of the vehicle 10. The decision as to whether to allow such non-vehicle operation processing functions is based at least in part on one or more vehicle energy conditions, as noted herein.

What is claimed is:

1. A method for using regenerative braking of a vehicle to power blockchain processing, comprising the steps of:
determining a vehicle energy condition;
determining whether the vehicle energy condition is greater than a predetermined threshold; and
powering one or more blockchain processors to perform blockchain processing when the vehicle energy condition satisfies the predetermined threshold.

2. The method of claim 1 which also includes determining that additional regenerative braking is presently occurring or is going to occur based on a projected route of the vehicle, and wherein the step of powering one or more processors occurs when both a vehicle battery is charged above a predetermined level and when additional regenerative braking is presently occurring or is going to occur based on a path of travel of the vehicle.

3. The method of claim 1, wherein the step of powering one or more block chain processors to perform blockchain processing is accomplished by providing power from a vehicle battery to the one or more processors.

4. The method of claim 1, wherein the step of powering one or more processors to perform blockchain processing starts after a vehicle battery has reached a predetermined level of charge or stops when the vehicle battery has fallen to a predetermined level of charge.

5. The method of claim 1, wherein the step of powering one or more processors to perform blockchain processing may be selectively started or stopped based on a location of the vehicle.

6. The method of claim 4, wherein the step of powering one or more processors to perform blockchain processing may be selectively started when the vehicle is on a road or is projected to be on a road having elevation decline greater than a predetermined amount.

7. The method of claim 1, wherein performing blockchain processing may be selectively stopped when one or more vehicle accessories require more than a predetermined amount of power from the vehicle battery.

8. The method of claim 1, wherein performing blockchain processing includes performing blockchain calculations as part of a processing pool.

9. The method of claim 1, wherein performing blockchain processing includes blockchain-based vehicle data tracking.

10. The method of claim 1, wherein performing blockchain processing includes collecting unconfirmed transactions from a network;
organizing transactions into a new block, referring to previous block creating chain of blocks; and
producing a hash that meets specific criteria of a blockchain.

11. A vehicle, comprising:
a regenerative braking system;
a battery communicated with the regenerative braking system to receive energy from the regenerative braking system;
a blockchain processor communicated with the battery to receive power from the battery; and
a controller that includes one or more processors, memory, and instructions or programs stored in the memory or otherwise accessible by the processors that is capable of communicating with a network configured to transmit and receive blockchain data, wherein the blockchain processor is either integrated with the controller or separate from the controller and is capable of communicating with the controller to:
determine a vehicle energy condition;
determine whether the vehicle energy condition is greater than a predetermined threshold; and
power the blockchain processor to perform blockchain processing when the vehicle energy condition meets or exceeds the predetermined threshold.

12. The vehicle of claim 11 which also includes determining that additional regenerative braking is presently occurring or is going to occur based on a projected route of the vehicle, and wherein the step of powering the blockchain processor occurs when both the battery is charged above a predetermined level and when additional regenerative braking is presently occurring or is going to occur based on a path of travel of the vehicle.

13. The system of claim 11, wherein powering the blockchain processor is accomplished by providing power from the battery to the blockchain processor.

14. The system of claim 11, wherein powering the blockchain processor starts after the battery has reached a predetermined level of charge, or powering the blockchain processor stops when the battery has fallen to a predetermined level of charge.

15. The system of claim 11, wherein powering the blockchain processor may be selectively started or stopped based on a location of the vehicle.

16. The system of claim 14, wherein powering the blockchain processor may be selectively started when the vehicle is on a road or is projected to be on a road having elevation decline greater than a predetermined amount.

17. The system of claim 11, wherein powering the blockchain processor may be selectively stopped when one or more vehicle accessories require more than a predetermined amount of power from the vehicle battery.

18. The system of claim 11, wherein performing blockchain processing includes performing blockchain calculations as part of a processing pool.

19. The system of claim 11, wherein performing blockchain processing includes blockchain-based vehicle data tracking.

20. The system of claim 11, wherein performing blockchain processing includes collecting unconfirmed transactions from a network;
organizing transactions into a new block, referring to previous block creating chain of blocks; and
producing a hash that meets specific criteria of a blockchain.
